(19) United States
(12) Patent Application Publication
(10) Pub. No.: US 2026/0141800 A1
(43) Pub. Date: May 21, 2026

(54) Automated Security Alert Resolution System

(71) Applicant: HiveWatch, Inc., El Segundo, CA (US)

(72) Inventors: Ryan Schonfeld, Redondo Beach, CA (US); Jordan Hill, Los Angeles, CA (US)

(21) Appl. No.: 19/377,329

(22) Filed: Nov. 3, 2025

Related U.S. Application Data
(60) Provisional application No. 63/720,937, filed on Nov. 15, 2024.

(51) Int. Cl. G08B 25/00; G06V 20/52; G07C 9/00

(52) U.S. Cl. CPC G08B 25/006; G07C 9/00571; G06V 20/52

(57) ABSTRACT

Methods, apparatuses, and systems for monitoring, evaluating, and responding to potential security incidents such as those that may occur at an access control location. In one embodiment, the disclosure is directed to a system and methods for automating the evaluation and response to potential security incidents based on a customer's standard operating procedures and “intelligent” evaluation of video, access control location signals, and incorporation of expected human operator actions.

### CROSS REFERENCE TO RELATED APPLICATION

This application claims the benefit of U.S. Provisional Application No. 63/720,937, filed Nov. 15, 2024, entitled “Access Control System”, the entire contents of which are incorporated herein for all purposes.

### BACKGROUND

Monitoring and controlling access to buildings, sites, and other physical structures used by a company or organization is an important part of maintaining privacy and security for both physical assets, personnel, and data. Conventional approaches include the use of video cameras, sensors to detect changes in positions of doors and windows, and control stations where human operators view incoming video and sensor readings to decide if further action is needed. If so, an operator may trigger an alarm, call for a response team, or investigate a situation themselves.

While effective, such conventional approaches have one or more disadvantages. These include scaling which typically requires additional operators, operator fatigue or inattention, a need to reduce false positive results, failing to recognize an actual event due to a high false alarm rate, and a lack of customizable actions that are based on a customer's standard operating procedures and/or site or event specific factors.

Embodiments of the disclosure overcome the disadvantages of conventional approaches to monitoring, evaluating, and responding to potential security incidents such as those that may occur at an access control location, both collectively and individually. In one embodiment, the disclosure is directed to a system and methods for automating the evaluation and response to potential security incidents based on a customer's standard operating procedures and “intelligent” evaluation of video, access control location signals, and incorporation of expected human operator actions.

### SUMMARY

The terms “invention,” “the invention,” “this invention,” “the present invention,” “the present disclosure,” or “the disclosure” as used herein refer broadly to all subject matter disclosed and/or described in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

In some embodiments, the disclosure is directed to a system and associated methods for automating the evaluation and response to potential security incidents based on a customer's standard operating procedures and “intelligent” evaluation of video, access control location signals, and incorporation of expected human operator actions. In one embodiment, the disclosed system/method may include the following elements, components, functions, processes, or operations:
Obtain customer statement of standard operating procedures (SOPs) for security and access control events for one or more of a specific incident type, a specific location or locations, and time of day;
Convert (each) SOP statement into a prompt for input to an LLM;
   In one embodiment, this is performed by use of a prompt “harness”, template, or structure;
   In some embodiments, context regarding a facility, an access control device, and operational history of the device are also added to the prompt to improve analysis accuracy and effectiveness of the actions taken;
   In some cases, and as a non-limiting example, a SOP may be in the form of an If-Then statement that includes multiple factors or features (such as location of event, sensor data collected, status or state of a door or other access point, or other relevant data or information);
The description of the SOP, after conversion or transformation into a prompt, is input to a Generative AI LLM, which outputs or generates a set of instructions for actions to be taken in response to the acquired data and information regarding a potential incident (such as sensor inputs, device status, or other information that may be included as part of a SOP);
   In one non-limiting example, such instructions may take the form of
      When the AI Operator sees [activity/person/clothing], automatically resolve the alarm;
      An example would be “When a Door Force Open Alarm happens, have the AI Operator determine if there was a person and if they were egressing a door. If so, then resolve the alarm with a note;
Incident data and information is received, and the system (also referred to as an AI Operator) then acknowledgesan incident to indicate it is being processed and evaluated;
   The incident data may relate to a security event, the status of an access control point, a sensor value, an alarm signal, etc.;
One or more video frames are acquired (if not acquired previously) that relate to the incident;
   Each frame may be processed to identify an object or situation shown in the video frame (such as an open access control point, a weapon, an animal, a “tailgater”, etc.);
   This processing may be performed using a trained model or classifier, as non-limiting examples;
   The availability of video frames or images is not a requirement, although when available such information is often useful to identify or resolve an incident;
The AI Operator, based on the acquired data and information, and the generated instruction set then determines one or more of the following:
   Whether the incident is real or a false positive;
   Whether the incident requires escalation or redirection to a person or specific office or department (such as fire, police, security, maintenance, etc.);
The AI Operator determines a state/status of the incident and may determine a desired action, and if relevant, initiates an appropriate response, guided by the SOP(s) or other instruction.

In one embodiment, the disclosure is directed to a system for automating the evaluation and response to potential security incidents based on a customer's standard operating procedures and “intelligent” evaluation of video, access control location signals, and incorporation of expected human operator actions. The system may include a set of computer-executable instructions, a memory or data storage element (such as a non-transitory computer-readable medium) on (or in) which the instructions are stored, and one or more electronic processors or co-processors. When executed by the processors or co-processors, the instructions cause the processors or co-processors (or a device of which they are part) to perform a set of operations that implement an embodiment of the disclosed method or methods.

In one embodiment, the disclosure is directed to a non-transitory computer readable medium containing a set of computer-executable instructions, wherein when the set of instructions are executed by one or more electronic processors or co-processors, the processors or co-processors (or a device of which they are part) perform a set of operations that implement an embodiment of the disclosed method or methods.

In some embodiments, the systems and methods disclosed herein may be used with a set of services or functionality provided through a SaaS or multi-tenant platform. The platform provides access to multiple entities, each with a separate account and associated data storage. Each account may correspond to a customer of the security services provided using an embodiment, a group of customers, a user, a set of users, an entity, a set or category of entities, an industry, a location, an organization, Guards, Operators, Program Managers, or Security Technology Technicians, as non-limiting examples. Each account may access one or more services, a set of which are instantiated in their account, and which implement one or more of the methods or functions disclosed and/or described herein.

In one embodiment, each customer or account may be implemented as a single tenant platform or system to prevent potential inadvertent cross-contamination or access to one customer's data by other customers.

In one embodiment, the disclosed and/or described security incident processing and evaluation approach may be implemented as a backend service on a SaaS platform that provides other services to accounts residing on the platform. In such an example implementation, the operator of the SaaS platform (or other form of system) may implement the disclosed data processing technique(s) while providing other services or access to other applications for accounts on the platform.

In yet another embodiment, the disclosed data processing technique(s) may be provided as a selected or requested service to one or more accounts residing on a different platform from the disclosed security service(s). In this way the disclosed approach may be applied to data generated within one or more platform accounts and/or to data generated by users of a different platform.

Other objects and advantages of the systems, apparatuses, and methods disclosed and/or described herein may be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the present disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1(a) is a flow chart or flow diagram illustrating a set of functions, operations, processes 100 that may be implemented in a system or platform to automate the evaluation and response to potential security incidents based on a customer's standard operating procedures and “intelligent” evaluation of video, access control location signals, and incorporation of expected human operator actions, in accordance with some embodiments;

FIG. 1(b) is an expanded flow chart or flow diagram of the set of functions, operations, or processes illustrated in FIG. 1(a);

FIG. 1(c) is a diagram illustrating the processing flow from acquisition of alarm or sensor data to creation of a prompt, input of the created prompt to an LLM, output of the LLM in the form of a JSON object, and determination of a resulting action or event, in accordance with some embodiments;

FIG. 2 is a diagram illustrating elements or components that may be present in a computer device or system configured to implement a method, process, function, or operation in accordance with an embodiment of the system and methods disclosed herein; and

FIGS. 3-5 are diagrams illustrating a SaaS or multi-tenant deployment of the system and methods disclosed and/or described herein for automating the evaluation and response to potential security incidents based on a customer's standard operating procedures and “intelligent” evaluation of video, access control location signals, and incorporation of expected human operator actions, in accordance with some embodiments.

Note that the same numbers are used throughout the disclosure and figures to reference like components and features.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, co-processor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user over a network (e.g., the Internet) through a transfer of instructions or an application that executes a set of instructions.

In some embodiments, the systems and methods disclosed herein may be used with a set of services or functionality provided through a SaaS or multi-tenant platform. The platform provides access to multiple entities, each with a separate account and associated data storage. Each account may correspond to a customer of the security services provided using an embodiment, a group of customers, a user, a set of users, an entity, a set or category of entities, an industry, a location, an organization, Guards, Operators, Program Managers, or Security Technology Technicians, as non-limiting examples. Each account may access one or more services, a set of which are instantiated in their account, and which implement one or more of the methods or functions disclosed and/or described herein.

In one embodiment, each customer or account may be implemented as a single tenant platform or system to prevent potential inadvertent cross-contamination or access to one customer's data by other customers.

In one embodiment, the disclosed and/or described security incident processing and evaluation approach may be implemented as a backend service on a SaaS platform that provides other services to accounts residing on the platform. In such an example implementation, the operator of the SaaS platform (or other form of system) may implement the disclosed data processing technique(s) while providing other services or access to other applications for accounts on the platform.

In yet another embodiment, the disclosed data processing technique(s) may be provided as a selected or requested service to one or more accounts residing on a different platform from the disclosed security service(s). In this way the disclosed approach may be applied to data generated within one or more platform accounts and/or to data generated by users of a different platform.

In some embodiments, one or more of the operations, functions, processes, or methods disclosed herein may be implemented by a specialized form of hardware, such as a programmable gate array, application specific integrated circuit (ASIC), or the like. Note that an embodiment of the disclosed methods may be implemented in the form of an application, a sub-routine that is part of a larger application, a “plug-in”, an extension to the functionality of a data processing system or platform, or other suitable form. The following detailed description is, therefore, not to be taken in a limiting sense.

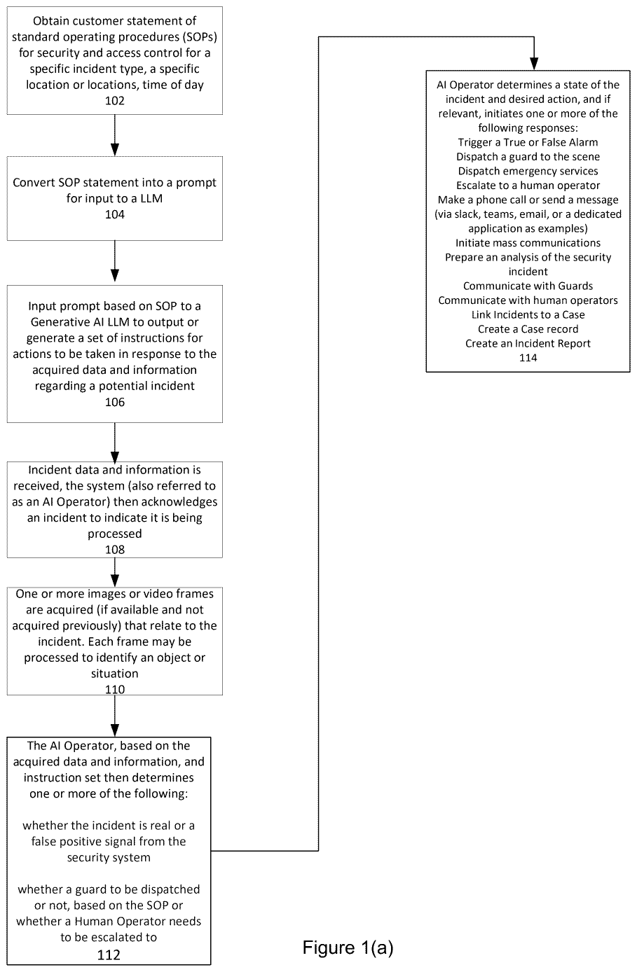

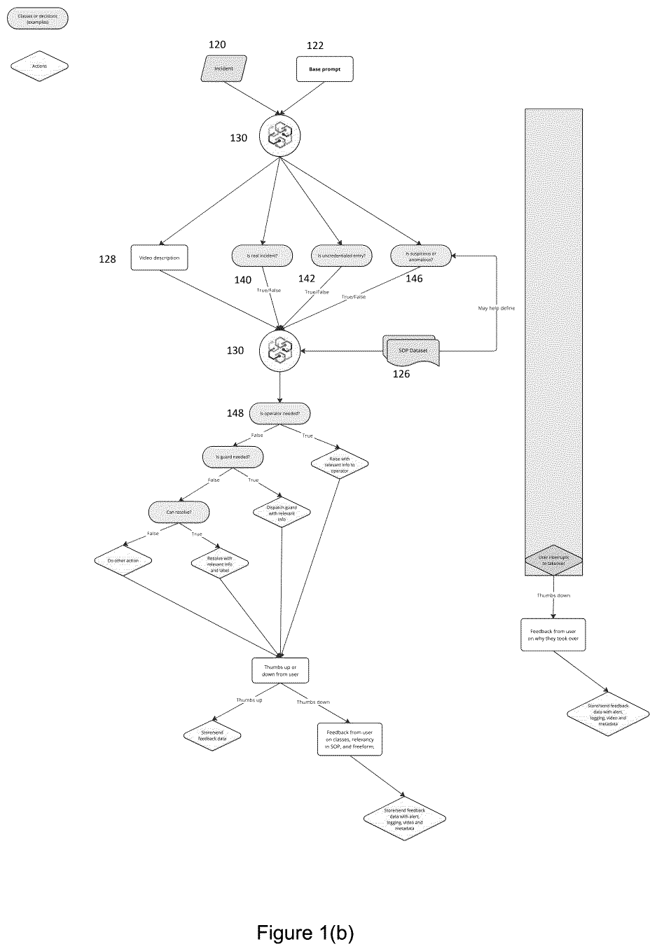

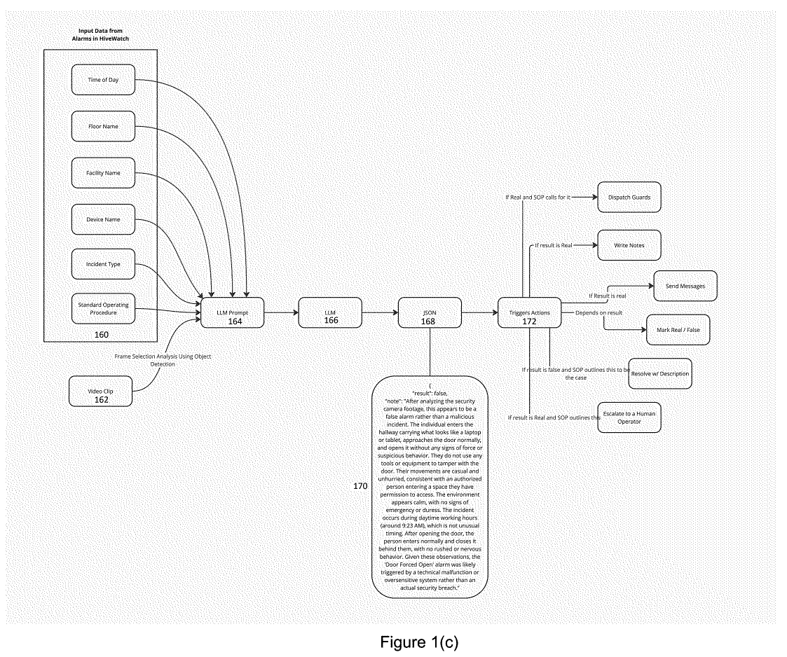

FIG. 1(a) is a flow chart or flow diagram illustrating a set of functions, operations, processes 100 that may be implemented in a system or platform to automate the evaluation and response to potential security incidents based on a customer's standard operating procedures and “intelligent” evaluation of video, access control location signals, and incorporation of expected human operator actions, in accordance with some embodiments.

As suggested by the figure, an embodiment of the disclosed processes may include one or more of the following steps, stages, functions, or operations:
Obtain customer statement of standard operating procedures (SOPs) for security and access control for one or more of a specific incident type, a specific location or locations, and time of day (as suggested by step or stage 102);
   In one embodiment, the SOP statement is in the form of text or a PDF;
   In one embodiment, a SOP statement is in the form of (or can be placed into the form of) an If-Then statement or rule;
      This may be accomplished using a suitable prompt to an LLM and/or a natural language processing technique, as non-limiting examples;
Convert SOP statement into a prompt for input to an LLM (step or stage 104);
   In one embodiment, this is performed by use of a prompt “harness”, template, or structure. As a non-limiting example, such a harness, template or structure may be of the form shown below:
      A set of consecutive or parallel rule conditions to evaluate a video clip, image, sensor data, or other information, followed by an action that happens based on the triggers:
         Conditions:
         No people interacting with the Door;
         No activity at all in a scene;
         If both conditions are met, then auto resolve the incident;
         If neither condition or only one condition is met, then flag the incident;
         Both resolutions have a text description that is applied to the incident;
   In some embodiments, context regarding a facility, device, and history of the device are also added to the prompt to improve analysis accuracy and actions taken;
   FIG. 1(c) is a diagram illustrating the processing flow from acquisition of alarm or sensor data to creation of a prompt, input of the created prompt to an LLM, output of the LLM in the form of a JSON object, and determination of a resulting action or event;
The description of the SOP, after conversion or transformation into a prompt, is input to a Generative AI LLM (such as that provided by Anthropic), which outputs or generates a set of instructions for actions to be taken in response to the acquired data and information regarding a potential incident (step or stage 106);
   As mentioned, in one embodiment, the output is in the form of a JSON object, such as that illustrated in FIG. 1(c);
   Other generative AI LLMs may instead be used, such as those provided by Open AI or Llama;
Incident data and information is received, the system (also referred to as an AI Operator) then acknowledges an incident to indicate it is being processed (as suggested by step or stage 108);
   One or more video frames are acquired (if not acquired previously) that relate to the incident (as suggested by step or stage 110);
      Each frame may be processed to identify an object or situation;
         In one embodiment, an LLM is used to perform object recognition, although other forms of object recognition (such as a trained image processor/classifier or model) may be used to reduce the number of frames input to the LLM for processing;
      As mentioned, the availability of video or images is not a requirement, although it is often useful in identifying or resolving an incident;
   The AI Operator, based on the acquired data and information, and generated instruction set then determines one or more of the following regarding the incident (as suggested by step or stage 112):
      Whether the incident is real or a false positive
      When False
         The Incident is resolved, it is marked as a “False” Incident, and the Incident Resolution is added as the description from the prompt as to why it decides that it was a “False” Incident;
      When True
         A note is added about the analysis of why it was true;
         True can also have other features that are listed in the SOP to flag particular anomalous activities;
         The system determines whether a guard needs to be dispatched or not, based on the SOP or whethera Human Operator needs to be escalated to;
      Other future actions that are notes in SOPS may also (or instead) be implemented;
   The AI Operator determines the status of the incident and may determine a desired action, and if relevant, initiates one or more of the following responses (as suggested by step or stage 114):
      Trigger a True or False Alarm;
      Dispatch a guard to the scene;
      Dispatch emergency services;
      Escalate to a human operator;
      Make a phone call or send a message (via slack, teams, email, or a dedicated application as non-limiting examples);
      Initiate mass communications;
      Prepare an analysis of the security incident;
      Communicate with Guards;
      Communicate with human operators;
      Link Incidents to a Case;
      Create a Case record;
      Create an Incident Report;
      Create a service ticket;
      Unlock a door or entry point;
      Lock a door or entry point;
      Send a message via intercom or other communication channel.

In some embodiments, the disclosed and/or described system and associated data processing may perform one or more of the following instead of or in addition to the mentioned actions:
Identifying specific objects or entities as directed by an SOP;
Identifying behaviors as directed by an SOP;
Sending emails or messages to other employees or security teams;
Sending voice messages to Guards;
Receiving and responding to voice messages from Guards;
Investigating and uploading historic video based on features of an incident video or image clip.

FIG. 1(b) is an expanded flow chart or flow diagram of the set of functions, operations, processes illustrated in FIG. 1(a). As shown in the figure, information about an incident 120 and a base prompt 122 are obtained by the disclosed system or platform (indicated by element or system 130 in the figure). The “incident” may represent a suspected security breach or violation of security policy (such as an access control location being prevented from closing, a person lacking credentials entering a facility, or a suspicious package or activity near an access control location, as non-limiting examples).

The incident data 120 and information are collected and a base prompt 122 for an LLM are obtained and may be subject to specific processing operations to place into a form in which further processing, analysis, or evaluation may occur. In one embodiment, a customer's SOP information (such as that found in SOP Dataset 126) is converted or transformed as needed into a prompt which when input to an LLM, generates a set of instructions for the AI Operator/system. The base prompt may be a “harness” or other format used to assist in creating the desired prompt.

The base or generated prompt is used to generate instructions for the AI Operator (130). The set of instructions and incident data/information are used with one or more video frames 128 (and in some cases, an accompanying description of what is shown in the video, and/or one or more image classifiers to identify objects or situations in a frame of the video) to analyze the available data and information and determine what step or steps to take in response based on the instructions (which, as mentioned are based on the customer's SOPs).

As shown in the figure, in one embodiment, the typical decisions made by the AI Operator 130 include (but are not limited to or required to include):
Is the incident a real one? (i.e., not a false positive) (as suggested by step or stage 140);
Is the incident a situation of an uncredentialed entry? (as suggested by 142);
Is the incident a suspicious or anomalous event or situation? (as suggested by 146);
Based on the AI Operator decision or evaluation of the incident data, and the guidance provided by the instructions based on the customer SOPs, an operator or guard may be requested (as suggested by 148);
If a guard or human operator is requested or needed, then they are expected to resolve the concern(s) raised by the incident. Whether resolved or not, the human operator or guard may provide feedback to the system, which may include incident related data, information, or observations, video, metadata, a suggested modification to a SOP or instruction in the instruction set, as non-limiting examples;
   As suggested by the figure, a set of decisions may be made after step or stage 148 that operate to determine if an operator or guard is needed and if they can resolve the concern raised by the access control monitoring system disclosed herein. This may include a user providing guidance on whether the concern was properly identified and resolved, and in some situations may include a user assuming control of the disposition of a generated alarm or report.

While use of a specific LLM or LLM provider is mentioned herein (I.e., Anthropic), other LLMs may instead be used for the purpose of transforming a statement of a SOP in the form of a prompt into a set of instructions for the AI Operator to follow. Examples include (but are not limited to) OpenAI or Llama.

Further, a trained LLM could be created that is more specific to security issues and events. Similarly, one or more trained image or vision processing models could be trained to act as classifiers and operate to identify or detect an object (e.g., gun, weapon, or contraband) person, animal, situation (e.g., door braced open or forced open), or event (e.g., argument or dispute), as non-limiting examples.

Such classifiers may be applied to one or more frames from a video to assist in analyzing and evaluating an incident situation. As a non-limiting example, if a proprietary LLM were to be constructed, it could use incident clips, response inputs (incident notes and resolution descriptions), real/false alarm or incident labels, historic access control events, historic incident clips, historic incidents, voice messages, and SOPs as training data and/or annotations/labels.

Once an incident is determined to be either “real” or a false positive, then the AI Operator and associated processing may annotate the incident report or data to “explain” its decision or outcome, determine if a guard or human operator is desired based at least in part on the customer SOP(s), and/or initiate one or more of the other activities or events mentioned herein (e.g., alarm, communication, generate report, request assistance from guard or human operator, or create a case and associated data and information).

FIG. 1(c) is a diagram illustrating the processing flow from acquisition of alarm or sensor data to creation of a prompt, input of the created prompt to an LLM, output of the LLM in the form of a JSON object, and determination of a resulting action or event.

As shown in the figure, in one embodiment, the following steps, stages, processes, operations, or functions may be performed:
1. Alarm Acknowledgement
   A rule is created for alarms of a specific type, device name, floor name, facility name, and time of day (as non-limiting examples of possible characteristics or fields used in describing the conditions for an alarm) for the AI Operator to respond to incidents created in the Hive Watch platform (the system or platform of the assignee). The AI Operator “Acknowledges” (typically almost immediately) and assumes ownership of responding to the incident in the Hive Watch platform that meets the rule criteria;
2. Input Data (as suggested by inputs 160)
   The Hive Watch platform (including its systems and processes) collects access control alarms and video clips 162 of cameras that are connected to the alarm source (which may be an access point or structure, as examples). The Hive Watch platform also collects a set of Standard Operating Procedures that are uploaded and labeled for the specific alarm type, device type, device name, floor name, facility name, and alarm creation timestamp;
      As suggested by inputs 160, such alarm signals may include one or more of time of day, floor name or ID, facility name or ID, device name or ID, incident type or category, and one or more SOPs;
3. Video Clip Processing
   In order to create a prompt, the video clip(s) 162 are separated into individual frames. A subset of frames may be collected using a mix of object detection for humans and motion and interval-based sampling of the video;
      Other approaches to interval-based sampling may be implemented to improve resource use and efficiency, such as using a subset of frames to digest the video;
4. LLM Prompt Creation
   The original input data and the processed video clip frames are combined into a prompt 164 that calibrates/initiates an LLM 166 to review the data in a security context and follow (adhere to) the Standard Operating Procedure(s) provided;
   The LLM is given an example of a JSON structure 168 that its output needs to be documented as or generated in the form of. The JSON is structured with a field for whether the incident is a real incident or a false positive, a field for the analysis, and fields for successive action, as non-limiting examples (as other aspects or features may prove useful to output from the LLM);
      A non-limiting example of such a JSON output is shown as element 170 in the figure;
5. LLM Processing
   The LLM 166 receives the constructed prompt 164, the LLM delivers the JSON output 170 to an alarm or further processing stage;
6. JSON Processing
   Using the fields in the JSON, if the alarm is false, the incident is marked as false, it is resolved, and the notes field of the JSON is used to construct a resolution description. If the alarm is true, then an incident note is created with the content of the notes field, a guard is dispatched, and the result is escalated to a human operator;
   In some embodiments, there may be additional JSON fields that determine whether a guard needs to be dispatched, and/or who needs to receive direct messages regarding the incident;
   As suggested by the figure, the output JSON 170 may be processed or interpreted to “trigger” one or more actions, events, or processes 172;
      Such actions, events, or processes 172 may include (as non-limiting examples) dispatching a guard, preparing notes or a report, generating and sending a message, marking an incident or labeling an incident as real or false, resolving an incident using a SOP as a guide, or escalating to a human operator for review and/or resolution;
7. Additional Embodiments or Implementations
   As mentioned, in some embodiments, there may be additional fields in the JSON to record information and/or initiate other actions. There may also be opportunities for the AI Operator to be able to respond to messages and notes created by guards in the field. Examples of additional data sources could be providing historic ACS event data or incident data from the device that the alarm/incident was generated from (this may assist in determining the device's reliability or output signal format and its interpretation).

In one sense, an embodiment performs one or more of the following functions, processes, or operations in response to the obtained data and information:
Validates the received Alarm/Alert (in one embodiment, based on the rules or rule criteria referred to herein);
Takes the actions (i.e., requests guard or human operator, generates further alarm or communications, or develops description/report of incident and outcome) that a Human Operator would typically take based on unique customer provided Standard Operating Procedures (SOP);
Generates a dynamic output/decision based on the automated analysis;
Provides a human reviewable report or decision record that may be used to “tune” a set of Standard Operating Procedures for the logic implemented by the AI Operator; and
May provide positive or negative feedback on the output or relevance of the output of the AI Operator.

In addition to the disclosed and/or described implementations, embodiments may also or instead include one or more of the following techniques, capabilities, or use cases:
Automated Camera Patrols-periodically check live camera feeds and/or video clips for security incidents that may be apparent from the feed, as may be informed by the Standard Operating Procedures;
Automated Device Health Reviews-“device health” (alarm or sensor health in some cases) can mean whether a device appears “on”, functioning properly, and/or if there is a reason performance may be degraded;
Automated Security Investigations-an ability to correlate various incidents within the platform based on common or relevant evidence (e.g., break-ins at different dates/times/locations that have common elements and that may suggest they're linked and/or suggest a security flaw);
   This may be accomplished by the use of statistical modeling, a trained model (e.g., a machine learning model or classifier), or a model capable of evaluating time-series data;
      Further examples of techniques that may be used include (but are not limited to):
         Object detection;
         Object Tracking;
         Context Inference;
         Supervised Learning; and
         Multimodal Rule Evaluation;
Chat Interactive Data Analysis;
   This may involve analyzing chat, messaging communications, or exchanges of data between employees, security personnel, or internal processes to identify indications of a potential problem, an alarm, or an event;
Automated Call Tree for Employee Security Concerns (for example, an employee calls in to the AI Operator through a voice channel and their concern is identified, processed, and acted upon);
Dispatching Robots/Drones-or more broadly, to dispatch another device to act and/or gather data at a location or site. Further, the AI Operator can, in addition to initiating the sending of robots/drones, send a door lock/door unlock command, deliver a voice “talk down” command, turn lights on/off, etc.

In one embodiment, a customer or user of the service provided may be able to configure aspects of the process flow and the data collection and processing. This may include providing an interface to enable a customer to select some of the input data, such as the Incidents that are triaged by the AI Operator and by what SOP they are interpreted, and may use the Incident Type, Facility Name, Device type, device category, Floor Name, and Time of Day inputs, as non-limiting input data examples.

Asa non-limiting example, a resolution description that may be generated and provided to a customer in the case of a false alarm might be as follows:
“Afteranalyzing the security camera footage, this appears to be a false alarm rather than a malicious incident. The individual enters the hallway carrying what looks like a laptop or tablet, approaches the door normally, and opens it without any signs of force or suspicious behavior. They do not use any tools or equipment to tamper with the door. Their movements are casual and unhurried, consistent with an authorized person entering a space they have permission to access. The environment appears calm, with no signs of emergency or duress. The incident occurs during daytime working hours (around 9:23 AM), which is not unusual timing. After opening the door, the person enters normally and closes it behind them, with no rushed or nervous behavior. Given these observations, the ‘Door Forced Open’ alarm was likely triggered by a technical malfunction or oversensitive system rather than an actual security breach”

Another non-limiting example of a resolution description or platform output might be as follows:
Assessment:
   The footage shows highly suspicious behavior that warrants further investigation. Dispatching available guards.
Reasoning:
   They appear to be attempting to open the door, possibly using some kind of tool or device held in their hand. The individual's body language is not consistent with someone walking down a hall. They are crouched down to avoid being sighted, looking around as if checking if anyone is watching while obscuring their face;
   After a brief period, they manage to open the secure door and quickly enter the room beyond. The speed and manner of entry, combined with the concealed identity, strongly suggest this is an unauthorized entry;
   The person immediately entering without a keycard or mobile credential once the door is open adds to concern regarding this suspicion activity.”

Embodiments provide a solution to multiple problems or disadvantages of conventional approaches to evaluation of signals from access control systems. In this regard, embodiments may include one or more of the following:
Automating review of camera alarm;
Automating review of access control alarm;
Automating redundant operator tasks;
Reducing or preventing operator fatigue;
Reduction of false positive alarms;
Reduction in missing real events because of relatively high false alarm rate;
Enabling a less costly and faster security alarm response;
Providing a higher overall accuracy in determining actual events (true positives);
Providing a scalable technology that doesn't require increasing human capital;
Enabling customizable actions based on unique end user Standard Operating Procedures;
Security monitoring and evaluation that is “always on” and operative.

In contrast, conventional approaches incorporate one or more of the following, with the associated disadvantages:
Guard Companies, Security Operator Outsourcing Companies, Managed Service Providers:
   Hires a group of people to respond to all of the alarms of all customers;
   They provide the management or the operators, the tools, and sometimes the physical real estate;
   They need additional people to scale;
   Since their people are servicing multiple accounts at the same time, they typically do not have the same level of efficiency or speed when responding to incidents;
   They may still not be able to address all of the alarms;
Some approaches involve the use of computer vision to create additional alarms or reduce false positive on camera-based alarms;
   These may include a dispatching capability, but do not automate the dispatching function;
   These services do not provide descriptions of the events detected or sensed;
Some approaches may use computer vision, but backstop false positives with human reviewing;
   These do not have an AI-based analysis of incident data;
   These cannot automate guard dispatch.

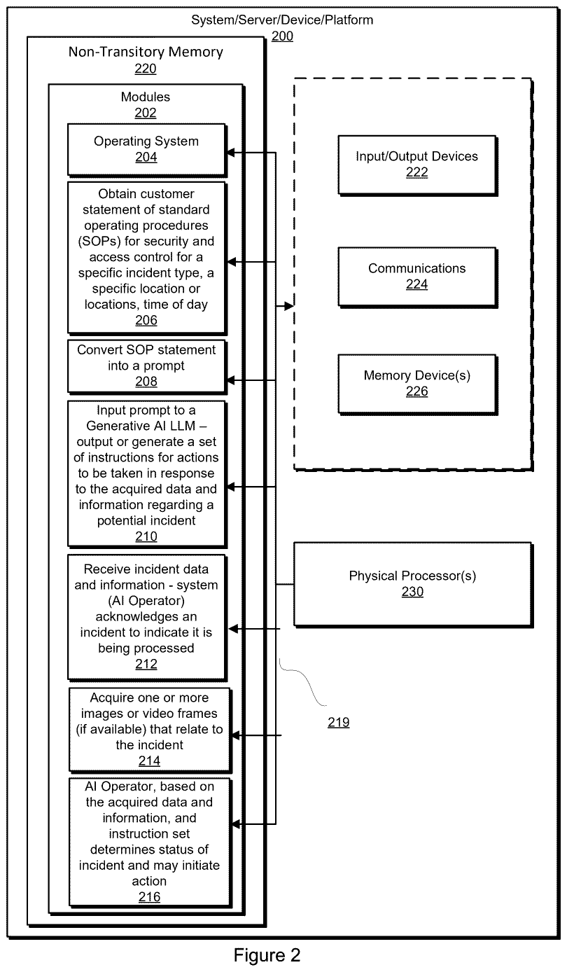

FIG. 2 is a diagram illustrating elements or components that may be present in a computing device or system configured to implement a method, process, function, or operation in accordance with an embodiment of the system and methods disclosed and/or described herein. As shown in the figure and as mentioned, in some embodiments, the system and methods may be implemented in the form of an apparatus that includes a processing element and set of computer-executable instructions. The executable instructions may be stored in (or on) a non-transitory memory or data storage element and be part of a software application arranged into a software architecture.

In general, an embodiment may be implemented using a set of software instructions that are intended to be executed by a suitably programmed processing element (such as a GPU, CPU, TPU, QPU, state machine, microprocessor, processor, co-processor, or controller, as non-limiting examples). In a complex application or system such instructions are typically arranged into “modules” (or submodules) with each such module (or submodule) typically performing a specific task, process, function, or operation. The entire set of modules may be controlled or coordinated in their operation by an operating system (OS) or other form of organizational platform.

Each application module or submodule may correspond to a particular function, method, process, or operation that is implemented by execution of the instructions contained in the module or submodule. Such function, method, process, or operation may include those used to implement one or more aspects of the disclosed and/or described systems and methods.

The application modules and/or submodules may include a suitable computer-executable code or set of instructions (e.g., as would be executed by a suitably programmed processor, microprocessor, co-processor, or CPU, as examples), such as computer-executable code corresponding to a programming language. For example, programming language source code may be compiled into computer-executable code. Alternatively, or in addition, the programming language may be an interpreted programming language such as a scripting language.

Modules or submodules may contain one or more sets of instructions for performing a method, operation, or function described with reference to the Figures, and the descriptions or disclosure of the methods, functions, and operations provided in the specification. These modules or submodules may include those illustrated but may also include a greater number or fewer numberthan those illustrated. The set of computer-executable instructions contained in a module or submodule may be executed by a programmed processor contained in a server, client device, network element, system, platform, or other component.

A module or submodule may contain instructions that are executed by a processor contained in more than one of a server, client device, network element, system, platform, or other component. Thus, in some embodiments, a plurality of electronic processors, with each being part of a separate device, server, network element, platform, or system may be responsible for executing all or a portion of the instructions contained in an illustrated module or submodule. Although FIG. 2 illustrates a set of modules or submodules which taken together perform multiple functions or operations, these functions or operations may be performed by different devices, apparatuses, platforms, or system elements, with certain of the modules or submodules (or instructions contained in them) being associated with those devices, apparatuses, platforms, or system elements.

As shown in FIG. 2, system 200 may represent a server or other form of computing or data processing system, platform, or device. Modules (or submodules) 202 each contain a set of computer-executable instructions, where when the set of instructions is executed by a suitable electronic processor or processors (such as that indicated in the figure by “Physical Processor(s) 230”), system (or server, platform, or device) 200 operates to perform a specific process, operation, function, or method. Modules 202 are stored in a non-transitory memory 220, which typically includes an Operating System module 204 that contains instructions used (among other functions) to access and control the execution of the instructions contained in other modules.

The modules or submodules 202 stored in memory 220 are accessed for purposes of transferring data and executing instructions by use of a “bus” or communications line 219, which also serves to permit processor(s) 230 to communicate with the modules or submodules for purposes of accessing and executing a set of instructions contained in a module or submodule. Bus or communications line 219 also permits processor(s) 230 to interact with other elements of system 200, such as input or output devices 222, communications elements 224 for exchanging data and information with devices external to system 200, and additional memory devices 226.

In some embodiments, the modules or submodules may comprise computer-executable software instructions that when executed by one or more electronic processors or co-processors cause the processors or co-processors (or a system or apparatus containing the processors or co-processors) to perform one or more of the following steps, stages, functions, operations, or processes:
Obtain customer statement of standard operating procedures (SOPs) for security and access control for one or more of a specific incident type, a specific location or locations, a time of day, or other characteristic (as suggested by module 206);
   In one embodiment, the SOP statement is in the form of text or a PDF;
   In one embodiment, each SOP may be converted or transformed into an “IF ..., Then ... statement;
Convert SOP statement into a prompt (module 208);
   In one embodiment, this is performed by use of a prompt “harness”, template, format, or structure;
   In some embodiments, context regarding a facility, device, and history of the device are also added to the prompt to improve analysis accuracy and actions taken;
The description of the SOP, after conversion or transformation into a prompt, is input to a Generative AI LLM, which outputs or generates a set of instructions for actions to be taken in response to the acquired data and information regarding a potential security related incident (module 210);
   As mentioned, FIG. 1(c) is a diagram illustrating the processing flow from acquisition of alarm or sensor data to creation of a prompt, input of the created prompt to an LLM, output of the LLM in the form of a JSON object, and determination of a resulting action or event;
Incident data and information is received, the system (also referred to as an AI Operator) then acknowledges an incident to indicate it is being processed (module 212);
One or more video frames are acquired (if available and not acquired previously) that relate to the incident (module 214);
   Each frame may be processed to identify an object or situation;
   As mentioned, this is not a requirement, although the availability of video frames or images is often helpful;
The AI Operator, based on the acquired data and information, and instruction set then determines one or more of the following, representing a status of the incident (module 216):
   Whether the incident is real or a false positive
   When False
      The Incident is resolved, it is marked as a “False” Incident, and the Incident Resolution is added as the description from the prompt as to why it decides that it was a “False” Incident
   When True
      A note is added about the analysis of why it was true
         True can also have other features that are listed in the SOP to flag particular anomalous activities
      It determines whetherit needs a guard to be dispatched or not, based on the SOP or whether a Human Operator needs to be escalated to;
   Other future actions that are notes in SOPS may also or instead be implemented;
The AI Operator determines a status of the incident and may determine a desired action, and if relevant, initiates one or more of the following responses (as suggested or indicated by a SOP that provides guidance to the system):
   Trigger a True or False Alarm
   Dispatch a guard to the scene
   Dispatch emergency services
   Escalate to a human operator
   Make a phone call or send a message (via slack, teams, email, or a dedicated application as examples)
   Initiate mass communications
   Prepare an analysis of the security incident
   Communicate with Guards
   Communicate with human operators
   Link Incidents to a Case
   Create a Case record
   Create an Incident Report;
   Create a service ticket;
   Unlock a door or entry point;
   Lock a door or entry point;
   Send a message via intercom or other communication channel.

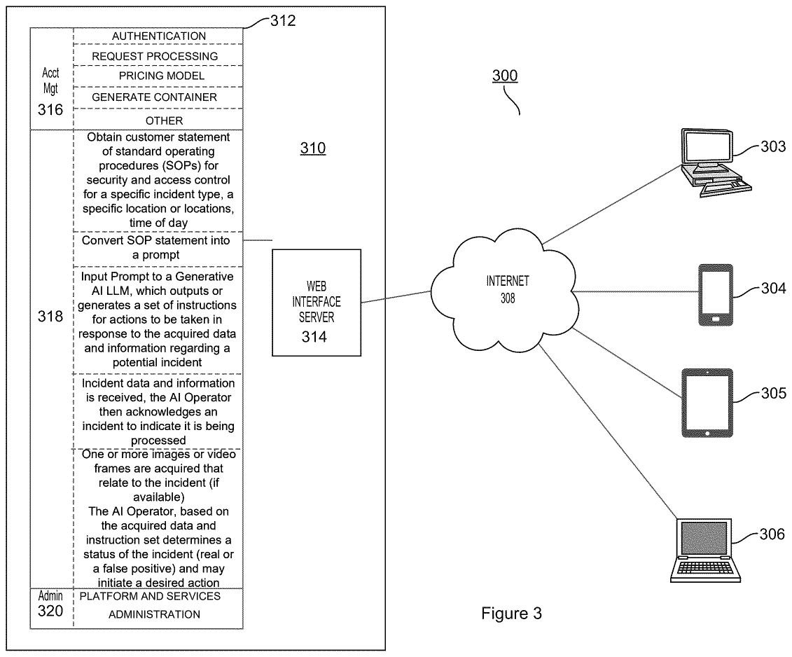

In some embodiments, the functionality and services provided by the system and methods disclosed and/or described herein may be made available to multiple users by accessing an account maintained by a server or service platform. Such a server or service platform may be termed a form of Software-as-a-Service (Saas). FIGS. 3-5 are diagrams illustrating a deployment of the system and methods disclosed and/or described herein for automating the evaluation and response to potential security incidents based on a customer's standard operating procedures and an “intelligent” evaluation of video, access control location signals, and incorporation of expected human operator actions, in accordance with some embodiments.

In some embodiments, the system or service(s) disclosed and/or described herein may be implemented as micro-services, processes, workflows, or functions performed in response to a user request (where in this situation, a “user” may be a set of upstream processes performed by the platform or system). The micro-services, processes, workflows, or functions may be performed by a server, data processing element, platform, or system. In some embodiments, the services may be provided by a service platform located “in the cloud”. In such embodiments, the platform is accessible through APIs and SDKs.

The disclosed and/or described processing and services may be provided as micro-services within the platform for each of multiple users, processes, process flows, departments, functions, or companies, as non-limiting examples. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications.

For example, such an architecture may be used to provide the data processing and incident analysis and evaluation capabilities disclosed and/or described herein as one of a set of services available through the platform.

Although in some embodiments, a platform or system of the type illustrated in FIGS. 3-5 may be operated by a 3^{rd} party provider to provide a specific set of business-related applications, in other embodiments, the platform may be operated by a provider and a different business may provide the applications or services for users through the platform. For example, some of the functions and services described with reference to FIGS. 3-5 may be provided by a 3^{rd} party with a provider of the disclosed and/or described incident analysis and evaluation services maintaining an account on the platform for each customer, location, organization, or access control point they monitor and service. In other embodiments, the provider of the disclosed and/or described incident analysis and evaluation services may operate the multi-tenant or SaaS platform themselves.

FIG. 3 is a diagram illustrating a system 300 in which an embodiment of the disclosure may be implemented or through which an embodiment of the services disclosed and/or described herein may be accessed. In accordance with the advantages of an application service provider (ASP) hosted business service system (such as a multi-tenant data processing platform), users of the services disclosed and/or described herein may comprise individuals, sites, locations, businesses, or organizations, as non-limiting examples.

In some use cases, a user associated with an account on the platform may access the services using a suitable client, including but not limited to desktop computers, laptop computers, tablet computers, scanners, or smartphones. Users interface with the service platform across the Internet 308 or another suitable communications network or combination of networks. Examples of suitable client devices include desktop computers 303, smartphones 304, tablet computers 305, or laptop computers 306.

System 310, which may be hosted by a third party, may include a set of services 312 and a web interface server 314, coupled as shown in FIG. 3. Either or both services 312 and web interface server 314 may be implemented on one or more different hardware systems and components, even though represented as singular units in FIG. 3.

Services 312 may include one or more functions or operations for automating the evaluation and response to potential security incidents based on a customer's standard operating procedures, an “intelligent” evaluation of video, access control location signals, and incorporation of expected human operator actions, in accordance with some embodiments. In such embodiments, the operator of the platform may expose these services via an external facing endpoint/service that can be accessed by customers or other users.

In some embodiments, the set of services or applications available to a customer or company may include one or more that perform the functions and methods disclosed in the specification and/or described with reference to the enclosed figures. As examples, in some embodiments, the set of applications, functions, operations or services made available through the platform or system 310 may include:
account management services 316, such as
   a process or service to authenticate a person, organization, department, or other form of user wishing to access the services/applications available through the platform (such as credentials, proof of purchase, or verification that an entity has been authorized to use the services of the platform);
   a process or service to generate a container or instantiation of the services, methodology, applications, functions, and operations described, where the instantiation may be customized for a particular user, process, department, entity, or company; and
   other forms of account management services;
a set 318 of data processing services, applications, or functionality, such as a process or service to:
   Obtain customer statement of standard operating procedures (SOPs) for security and access control for (as examples) one or more of a specific incident type, a specific location or locations, and time of day;
   Convert each SOP statement into a prompt;
   The description of the SOP, after conversion or transformation into a prompt, is input to a Generative AILLM, which outputs or generates a set of instructions for actions to be taken in response to the acquired data and information regarding a potential incident;
   Incident data and information is received, the system (also referred to as an AI Operator) then acknowledges an incident to indicate it is being processed;
   One or more video frames are acquired (if available and not acquired previously) that relate to the incident;
   The AI Operator, based on the acquired data and information, and instruction set then determines a status of the incident (real or a false positive):
      The AI Operator determines a status of the incident and may determine a desired action, and if relevant, initiates one or more of the indicated responses (as determined or guided by the SOPs);
administrative services 320, such as
   a process or services to enable the provider of the data processing services and/or the platform to administer and configure the processes and services provided to a user or consumer (an entity, organization, department, site, or location, as non-limiting examples).

The platform or system shown in FIG. 3 may be hosted on a distributed computing system made up of at least one, but typically multiple, “servers.” A server is a physical computer dedicated to providing data storage and an execution environment for one or more software applications or services intended to serve the needs of the users of other computers (or processes) that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

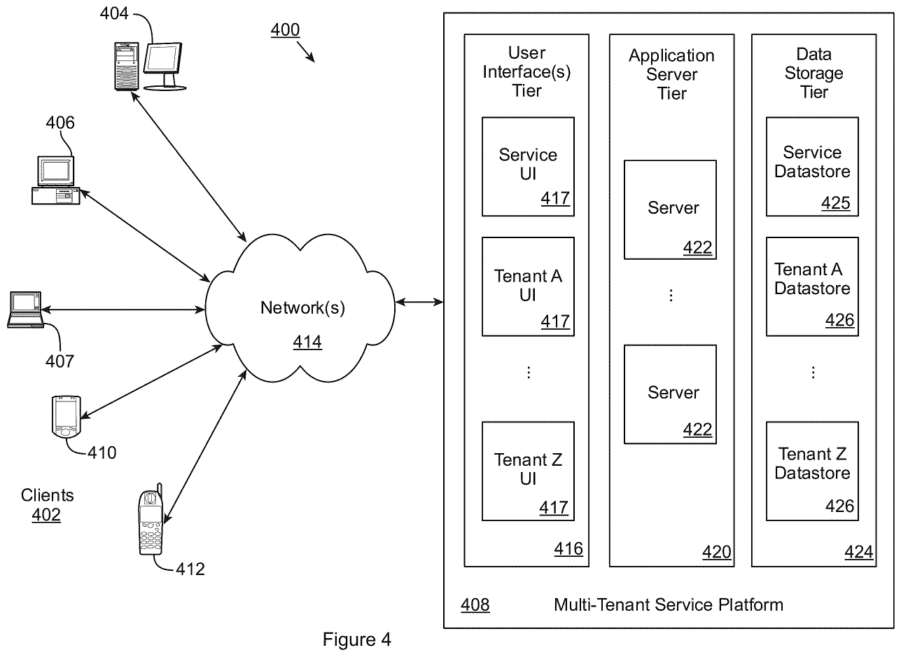

FIG. 4 is a diagram illustrating elements or components of an example operating environment 400 in which an embodiment of the disclosure may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (such as one or more electronic processors, microprocessors, central processing units (CPU), or controllers). Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data fora user or “tenant” of the service (depicted as “Service UI” in the figure), as well as one or more user interfaces that have been specialized/customized in accordance with user specific requirements (e.g., represented by “Tenant A UI”, ..., “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, or causing the execution of specific data processing operations.

Each application server 422 or processing tier 420 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with a suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information.

Such functions or applications are typically implemented by one or more modules or submodules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described herein in the context of a multi-tenant platform, where individual instantiations of a business'data processing workflow (such as the incident analysis and evaluation processing disclosed and/or described herein) are provided to users, with each company/business/location/site representing a tenant of the platform.

One advantage to such multi-tenant platforms is the ability for each tenant to customize their instantiation of the data processing workflow to that tenant's specific business needs or operational methods. In some cases, each tenant may be a business or entity that uses the multi-tenant platform to provide business services and functionality to multiple users.

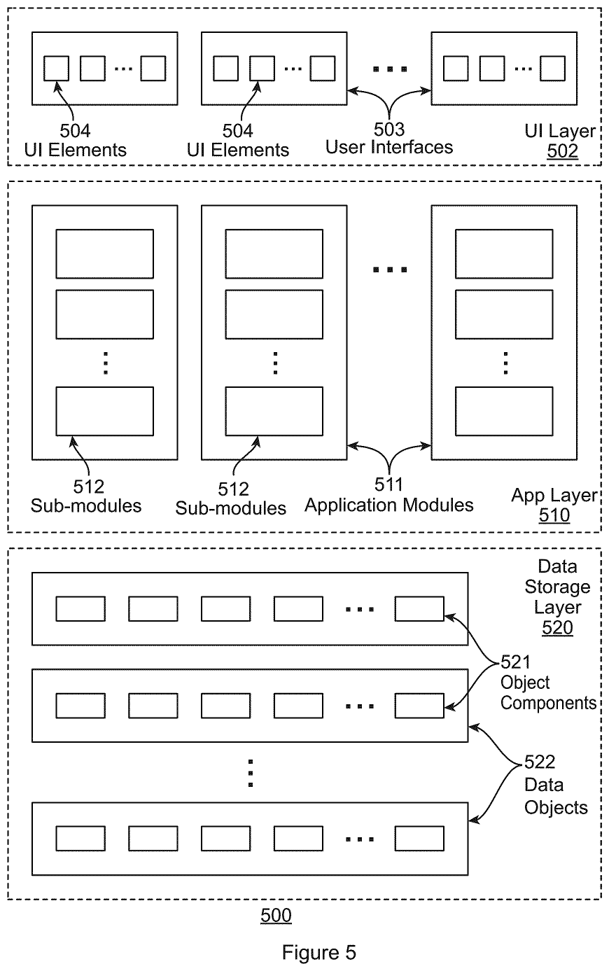

FIG. 5 is a diagram illustrating additional details of the elements or components of the multi-tenant distributed computing service platform of FIG. 4, in which an embodiment of the disclosure may be implemented. The software architecture shown in FIG. 5 represents an example of an architecture which may be used to implement an embodiment of the invention.

In general, an embodiment of the invention may be implemented using a set of software instructions that are executed by a suitably programmed processing element (such as a CPU, GPU, microprocessor, processor, co-processor, or controller, as non-limiting examples). In a complex system such instructions are typically arranged into “modules” or submodules with each such module (or submodule) performing a specific task, process, function, or operation. The entire set of modules and submodules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment of the disclosure may be implemented. The example architecture includes a user interface layer or tier 502 having one or more user interfaces 503. Examples of such user interfaces include graphical user interfaces and application programming interfaces (APIs). Each user interface may include one or more user interface (UI) elements 504.

For example, users may interact with user interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more submodules 512. Each application module 511 or submodule 512 may correspond to a function, method, process, or operation that is implemented by the module or submodule (e.g., a function or process related to providing data processing and services to a user of the platform). Such function, method, process, or operation may include those used to implement one or more aspects of the disclosed system and methods, such as for one or more of the components, elements, processes, operations, or functions disclosed herein and/or described with reference to the Figures:
Obtain customer statement of standard operating procedures (SOPs) for security and access control for one or more of a specific incident type, a specific location or locations, and time of day (as examples);
   In one non-limiting example, each SOP may be converted or transformed into a statement of the form “If ..., Then ...”;
Convert SOP statement(s) into a prompt;
The description of the SOP, after conversion or transformation into a prompt, is input to a Generative AI LLM, which outputs or generates a set of instructions for actions to be taken in response to the acquired data and information regarding a potential incident;
Incident data and information is received, the system (also referred to as an AI Operator herein) then acknowledges an incident to indicate it is being processed;
One or more video frames are acquired (if available and not acquired previously) that relate to the incident;
The AI Operator, based on the acquired data and information, and instruction set then determines a status of the incident (real or a false positive):
   O The AI Operator determines a status of the incident and may determine a desired action, and if relevant, initiates one or more of the indicated responses (as guided by the SOPs).

The application modules and/or submodules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module (and associated submodules). Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments illustrated in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

This disclosure includes the following embodiments or clauses:
1. A method of performing a security function, comprising:
obtaining a customer statement of standard operating procedures (SOPs) for security and access control for a specific incident type or specific location;
converting the SOP statement into a prompt;
inputting the prompt to a generative AI LLM to output a set of instructions for actions to be taken in response to acquired data and information regarding an incident;
receiving a set of data and information for a specific incident;
determining if the specific incident is a real one or a false positive; and
determining and initiating a desired action if the specific incident is a real one.
2. The method of clause 1, wherein converting the SOP statement into a prompt further comprises using a prompt format that includes one or more of a time of day, a floor name, a facility name, a device name, an incident type, a standard operating procedure, and an example of a desired output format.
3. The method of clause 1, wherein the set of data and information for the specific incident includes one or more of sensor signals, images, and video.
4. The method of clause 3, wherein if available, the sensor signals include a signal or signals indicating an open or closed access control point, and if available, the images and video include an image or video of the access control point.
5. The method of clause 1, wherein the desired action is one or more of triggering a True or False Alarm, dispatching a guard to the scene, dispatching an emergency service, escalating to a human operator, initiating a communication, preparing an analysis of the security incident, creating a case record, creating an incident report, or locking or unlocking a door or entry point.
6. A system for performing a security function, comprising:
a non-transitory computer-readable medium including a set of computer-executable instructions;
one or more electronic processors configured to execute the set of computer-executable instructions, wherein when executed, the instructions cause the one or more electronic processors to
   obtain a customer statement of standard operating procedures (SOPs) for security and access control for a specific incident type or specific location;
   convert the SOP statement into a prompt;
   input the prompt to a generative AI LLM to output a set of instructions for actions to be taken in response to acquired data and information regarding an incident;
   receive a set of data and information for a specific incident;
   determine if the specific incident is a real one or a false positive; and
   determine and initiate a desired action if the specific incident is a real one.
7. One or more non-transitory computer-readable media including a set of computer-executable instructions that when executed by one or more programmed electronic processors, cause the processors to:
obtain a customer statement of standard operating procedures (SOPs) for security and access control for a specific incident type or specific location;
convert the SOP statement into a prompt;
input the prompt to a generative AI LLM to output a set of instructions for actions to be taken in response to acquired data and information regarding an incident;
receive a set of data and information for a specific incident;
determine if the specific incident is a real one or a false positive; and
determine and initiate a desired action if the specific incident is a real one.

Embodiments of the disclosure may be implemented in the form of control logic using computer software in a modular or integrated manner. Based on the disclosure and teachings provided herein, a person of ordinary skill in the art will recognize other ways and/or methods to implement an embodiment using hardware, software, or a combination of hardware and software.

In some embodiments, certain of the methods, models, processes, or functions disclosed and/or described herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to different combinations of inputs from the previous layers.

Training of a network is performed using a “labeled” dataset of inputs in an assortment of representative input patterns (or datasets) that are associated with their intended output response. Training uses general-purpose methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Machine learning (ML) is used to analyze data and assist in making decisions in multiple industries. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A machine learning model can predict or infer an outcome based on the training data and labels and be used as part of a decision process. When trained, the model will operate on a new element of input data to generate the correct (or most likely correct) label or classification as an output.

In some examples, a neural network may be implemented based on multiple and/or different types of topologies and/or architectures including deep neural networks with fully connected (e.g., dense) layers, Long Short-Term Memory (LSTM) layers, convolutional layers, Temporal Convolutional Layers (TCL), other suitable types of deep neural network topology and/or architectures, or a combination thereof.

A neural network may have different types of output layers including, without limitation, output layers with logistic sigmoid activation functions, hyperbolic tangent activation functions, linear units, rectified linear units, other suitable types of nonlinear units, or a combination thereof.

Any of the software components, processes or functions described in this application may be implemented as software code to be executed by a processor using any suitable computer language such as Python, Java, Javascript, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to here in may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods disclosed and/or described herein. The computer program instructions may also be stored in (or on) a computer-readable memory that may direct a computer or other programmable data processing apparatus to function in a specific manner, such that the instructions stored in the computer-readable memory produce an article of manufacture including instruction means that implement one or more of the functions, operations, processes, or methods disclosed and/or described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. A method of performing a security function, comprising:
obtaining a customer statement of standard operating procedures (SOPs) for security and access control for a specific incident type or specific location;
converting the SOP statement into a prompt;
inputting the prompt to a generative AI LLM to output a set of instructions for actions to be taken in response to acquired data and information regarding an incident;
receiving a set of data and information for a specific incident;
determining if the specific incident is a real one or a false positive; and
determining and initiating a desired action if the specific incident is a real one.

2. The method of claim 1, wherein converting the SOP statement into a prompt further comprises using a prompt format that includes one or more of a time of day, a floor name, a facility name, a device name, an incident type, a standard operating procedure, and an example of a desired output format.

3. The method of claim 1, wherein the set of data and information for the specific incident includes one or more of sensor signals, images, and video.

4. The method of clause 3, wherein if available, the sensor signals include a signal or signals indicating an open or closed access control point, and if available, the images and video include an image or video of the access control point.

5. The method of claim 1, wherein the desired action is one or more of triggering a True or False Alarm, dispatching a guard to the scene, dispatch an emergency service, escalate to a human operator, initiating a communication, preparing an analysis of the security incident, creating a case record, creating an incident report, or locking or unlocking a door or entry point.

6. A system for performing a security function, comprising:
a non-transitory computer-readable medium including a set of computer-executable instructions;
one or more electronic processors configured to execute the set of computer-executable instructions, wherein when executed, the instructions cause the one or more electronic processors to
obtain a customer statement of standard operating procedures (SOPs) for security and access control for a specific incident type or specific location;
convert the SOP statement into a prompt;
input the prompt to a generative AI LLM to output a set of instructions for actions to be taken in response to acquired data and information regarding an incident;
receive a set of data and information for a specific incident;
determine if the specific incident is a real one or a false positive; and
determine and initiate a desired action if the specific incident is a real one.

7. The system of claim 6, wherein converting the SOP statement into a prompt further comprises using a prompt format that includes one or more of a time of day, a floor name, a facility name, a device name, an incident type, a standard operating procedure, and an example of a desired output format.

8. The system of claim 6, wherein the set of data and information for the specific incident includes one or more of sensor signals, images, and video.

9. The system of claim 8, wherein if available, the sensor signals include a signal or signals indicating an open or closed access control point, and if available, the images and video include an image or video of the access control point.

10. The method of claim 1, wherein the desired action is one or more of triggering a True or False Alarm, dispatching a guard to the scene, dispatching an emergency service, escalating to a human operator, initiating a communication, preparing an analysis of the security incident, creating a case record, creating an incident report, or locking or unlocking a door or entry point.

11. One or more non-transitory computer-readable media including a set of computer-executable instructions that when executed by one or more programmed electronic processors, cause the processors to:
obtain a customer statement of standard operating procedures (SOPs) for security and access control for a specific incident type or specific location;
convert the SOP statement into a prompt;
input the prompt to a generative AI LLM to output a set of instructions for actions to be taken in response to acquired data and information regarding an incident;
receive a set of data and information for a specific incident;
determine if the specific incident is a real one or a false positive; and
determine and initiate a desired action if the specific incident is a real one.

12. The one or more non-transitory computer-readable media of claim 11, wherein converting the SOP statement into a prompt further comprises using a prompt format that includes one or more of a time of day, a floor name, a facility name, a device name, an incident type, a standard operating procedure, and an example of a desired output format.

13. The one or more non-transitory computer-readable media of claim 11, wherein the set of data and information for the specific incident includes one or more of sensor signals, images, and video.

14. The one or more non-transitory computer-readable media of claim 13, wherein if available, the sensor signals include a signal or signals indicating an open or closed access control point, and if available, the images and video include an image or video of the access control point.

15. The one or more non-transitory computer-readable media of claim 11, wherein the desired action is one or more of triggering a True or False Alarm, dispatching a guard to the scene, dispatching an emergency service, escalating to a human operator, initiating a communication, preparing an analysis of the security incident, creating a case record, creating an incident report, or locking or unlocking a door or entry point.
